(19) United States
(12) Patent Application Publication
(10) Pub. No.: US 2008/0270910 A1
(43) Pub. Date: Oct. 30, 2008

(54) USER SELECTION OF A REMOTE SESSION

(76) Inventors: Derek J. Lukasik, Fort Collins, CO (US); Roland M. Hochmuth, Fort Collins, CO (US); Gabriel Salazar, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/742,496

(22) Filed: Apr. 30, 2007

(51) Int. Cl. G06F 3/00

(52) U.S. Cl. 715/740

(57) ABSTRACT

Methods and systems for user selection of a remote session are described herein. At least some illustrative embodiments comprise a method that comprises presenting display information to a user (while in a first windowing mode) from a first remote session before entering a setup mode and from a second remote session after exiting the setup mode, entering the setup mode and selecting (by the user) the second remote session while continuing to present the display information from the first remote session without changing to a second windowing mode, and preventing contemporaneous presenting of display information from both the first and the second remote sessions while not in the setup mode.

### BACKGROUND

With the proliferation of high speed networks and Internet access, an increasing number of corporate entities now provide their employees with remote access to corporate computers. This enables employees to work from home or other locations during normal working hours (sometimes referred to as telecommuting), as well as after-hours and on weekends. Such remote access to computer resources is provided by a variety of software packages, such as, for example, Remote Desktop Client interacting with Terminal Services, both by Microsoft®. These and other similar software packages can provide access to a collection of terminal sessions and virtual computers selected from a pool, or access to specific individual computers. Users log into a “remote session” in which the user's desktop appears as the desktop would appear if the user were logged in locally to an actual, distinct computer.

At least some remote access software programs enable a single user workstation to establish remote sessions with multiple remote computers. In such systems, the client side of the remote access program relies on the underlying windowing environment to control and re-direct the flow of inputs provided by the user to the remote computer, as well as the presentation of graphical displays and audio presented by the remote computer to the user. In such windowing environments, input is directed to a particular remote session window based on which window has the “focus,” i.e., which window is selected by the user, either in windowed or full-screen mode.

Because at least some remote access software programs rely on the underlying windowing system to manage session windows, switching between sessions can be cumbersome and may require a significant number of user actions (e.g., mouse clicks and key sequences). Selecting a particular window can be made even more cumbersome by the lack of a quick and intuitive way to identify a session window. User may have to maximize each session window in sequence in order to identify and select the desired session window. Although icons and window titles provide some information, the icons for multiple remote sessions may be the same for every session (since the icon reflects the program identity, not the session identity), and the window title may include a cryptic session name, or no session name at all. Even if the session name is somewhat informative, the user still has to keep track of which session name is associated with a particular activity.

### BRIEF DESCRIPTION OF THE DRAWINGS

For a detailed description of exemplary embodiments of the invention, reference will now be made to the accompanying drawings in which:

FIG. 1 shows a system comprising a receiving station and a sending station, configured to operate in accordance with at least some illustrative embodiments;

FIG. 2A shows an example of a system configuration, suitable for use as either the receiving station or the sending station of FIG. 1, in accordance with at least some illustrative embodiments;

FIG. 2B shows a block diagram of the system configuration of FIG. 2A, in accordance with at least some illustrative embodiments;

FIG. 3 shows a system comprising a receiving station and multiple sending stations, configured to operate in accordance with at least some illustrative embodiments;

FIG. 4 shows a session selection thumbnail display, in accordance with at least some illustrative embodiments; and

FIG. 5 shows a method for selecting one of a plurality of remote sessions, in accordance with at least some illustrative embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Additionally, the term “system” refers to a collection of two or more hardware and/or software components, and may be used to refer to an electronic device, such as a computer, a portion of a computer, a combination of computers, etc. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

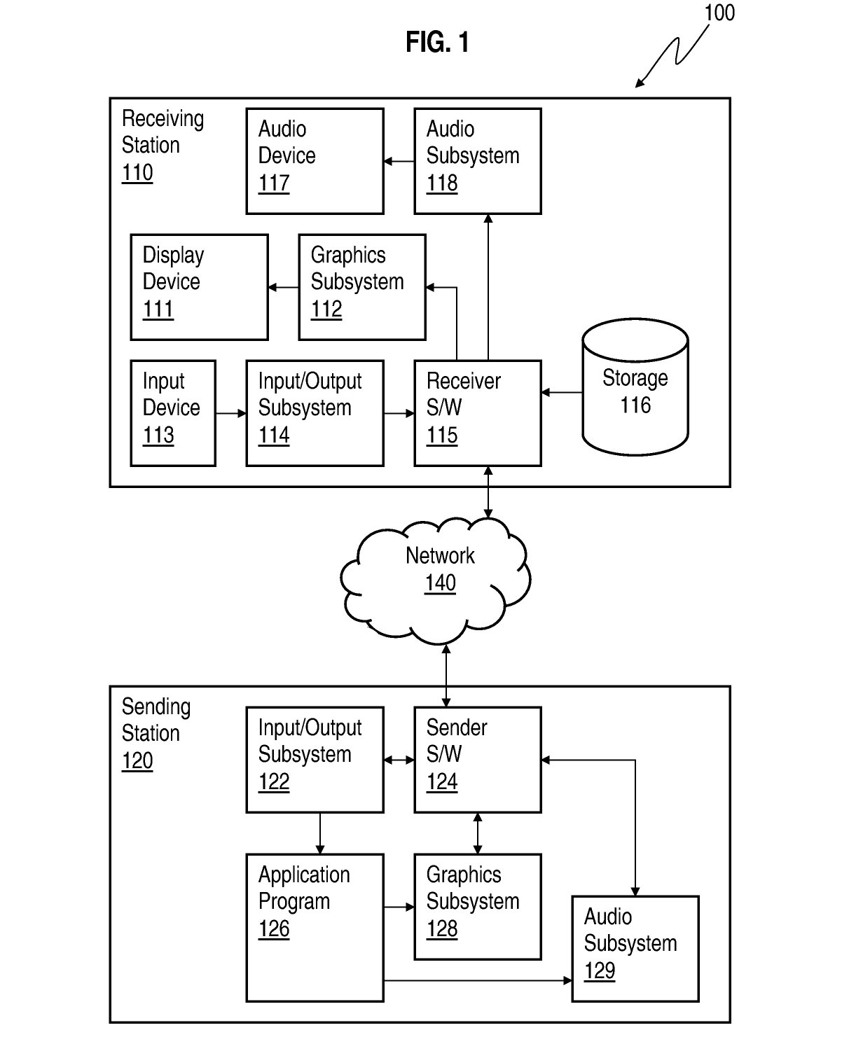

FIG. 1 shows a computer system 100, in accordance with at least some illustrative embodiments, in which a receiving station 110 interacts with a sending station 120. Receiving station 110 and sending station 120 couple to each other via a network 140, such as, for example, the Internet. Receiving station 110 comprises logic that provides some or all of the functionality of receiving station 110. The logic of receiving station 110 may comprise software executing on a processor (e.g., receiver software (Receiver S/W) 115 as shown in FIG. 1), dedicated or programmable digital hardware, or a combination of both software and hardware.

Receiving station 110 also comprises graphics subsystem 112 and display device 111, which provide graphical images to a user of receiving station 110; input/output subsystem 114 and input device 113 which receive input data from the user; audio subsystem 118 and audio device 117 which provide audio to the user of receiving station 110; and storage device 116, which may be used to store at least some configuration information used by receiver software 115. Receiver software 115 receives messages from sending station 120. The messages comprise video data that is forwarded to graphics subsystem 112, which displays the information to the user via display device 111, as well as audio data that is forwarded to audio subsystem 118 for presentation to the user via audio device 117. The user provides input via input device 113, which is forwarded by input/output subsystem 114 to receiver software 115. Receiver software 115 subsequently sends one or more messages to sending station 120 comprising the input data received from input/output subsystem 114. The input data comprises data that originates from input device 113, which in at least some illustrative embodiments includes a keyboard and mouse.

Continuing to refer to the illustrative embodiment of FIG. 1, sending station 120 comprises sender software (Sender S/W) 124 and application program 126, each comprising executable code executing on sending station 120. Sender software 124 provides some or all of the functionality of sending station 120. Sending station 120 also comprises input/output subsystem 122 and graphics subsystem 128. Sender software 124 receives messages from receiving station 110 with input data originated by the user operating receiving station 110 (via input device 113). The input data is forwarded to application program 126 via input/output subsystem 122. Graphical and audio data generated by application program 126 are respectively sent to graphics subsystem 128 and audio subsystem 129, which each respectively forward the graphical and audio data to sender software 124. Sender software formats the graphical and audio data into messages that are transmitted to receiving station 110, which displays the graphical data to the user as previously described, and presents the audio to the user via audio devices such as speakers or headphones.

Sender software 124 and receiver software 115 together act as an abstraction layer that hides the existence of the underlying network from both the user operating receiver station 110 and application program 126 executing on sending station 120. By hiding the underlying network, the user interacts with application 126 as if it were executing locally on receiving station 110, and application 126 interacts with the user as if the user were directly operating sending station 120 via locally-coupled devices. This infrastructure enables the creation of one or more “remote sessions,” also sometimes referred to as “remote access sessions,” “remote desktop sessions,” “remote visualization sessions,” and “remote graphics sessions.” A remote session is a process by which two computers, a receiving station that initiates the session and a sending station that hosts the session, interact to provide a user at the receiving station with a computing environment that appears to the user as if the user were logged directly into the sending station.

The host sending station provides graphical information to the receiving station within one or more remote session messages, which displays the images represented by the information as the images would be displayed at the sending station if the user were logged-in locally to the sending station. The graphical information comprises sequential bits of data, grouped to represent pixels displayed on a display. The data is transmitted in the time-sequenced order in which the pixels are drawn on a display (e.g., left to right for each pixel within a scan line, and top to bottom for each scan line in sequence). Audio information is also transmitted in digital form within one or more remote session messages, with groupings of bits representing encoded audio that is decoded and presented as analog audio to the user as if the user were logged-in locally to the sending station. Likewise, the user operates the receiving station, which provides input data (e.g., keyboard characters and mouse coordinate data) to the sending station, and the input data is received and processed by the sending station in the same manner as inputs provided by a locally logged-in user.

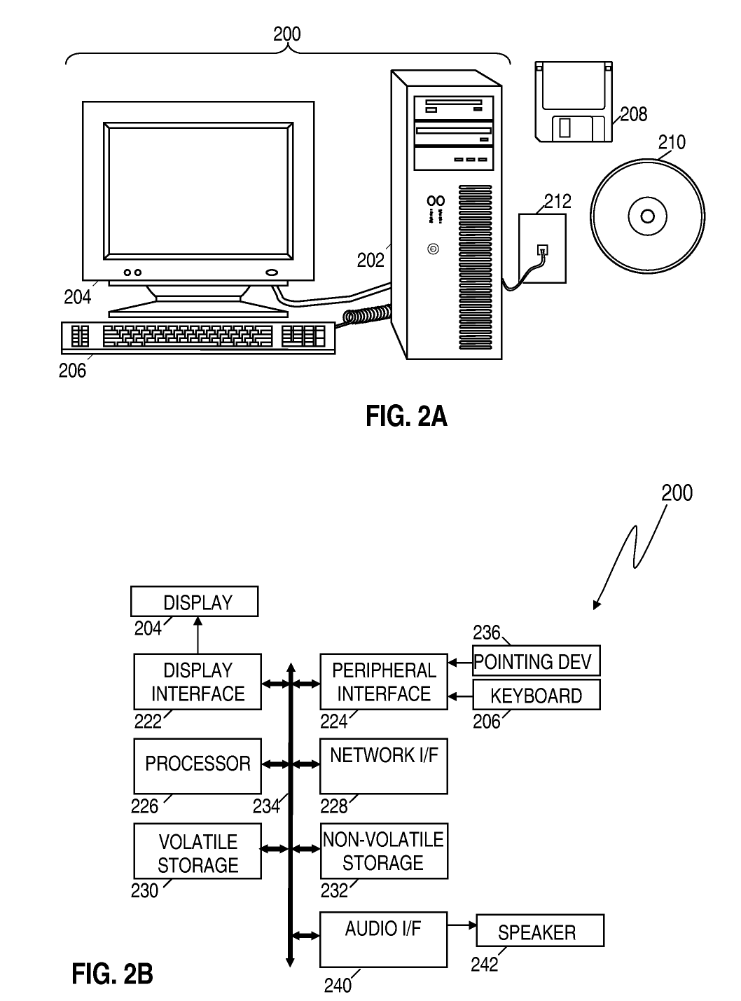

FIGS. 2A and 2B show an illustrative system configuration 200 suitable for implementing receiving station 110 and sending station 120 of FIG. 1. As shown, the illustrative system configuration 200 comprises a chassis 202, a display 204, and an input device 206. The system configuration 200 comprises a processor 226, volatile storage 230, and non-volatile storage 232. Volatile storage 230 comprises a computer-readable medium such as random access memory (RAM). Non-volatile storage 232 comprises a computer-readable medium such as flash RAM, read-only memory (ROM), a hard disk drive, a floppy disk (e.g., floppy 208), a compact disk read-only memory (CD-ROM, e.g., CD 210), and combinations thereof.

The computer-readable media of both volatile storage 230 and non-volatile storage 232 comprise, for example, software that is executed by processor 226 and provides both receiving station 110 and sending station 120 with some or all of the functionality described herein. The system configuration 200 also comprises a network interface (Network I/F) 228 that enables the system configuration 200 to receive information via a local area network and/or a wired or wireless wide area network, represented in the example of FIG. 2A by Ethernet jack 212. A display interface 222 couples to the display 204. A user interacts with the station via the input device 206 and/or pointing device (Pointing Dev) 236 (e.g., a mouse), which couples to a peripheral interface 224. The display 204, together with the input device 206 and/or the pointing device 236, may operate together as a user interface.

System 200 may be a bus-based computer, with the bus 234 interconnecting the various elements shown in FIG. 2B. The peripheral interface 224 accepts signals from the keyboard 206 and other input devices such as a pointing device 236, and transforms the signals into a form suitable for communication on the bus 234. The display interface 222 may comprise a video card or other suitable display interface that accepts information from the bus 234 and transforms it into a form suitable for the display 204. The audio interface 240 may comprise a sound card or other suitable audio interface that accepts information from the bus 234 and transforms it into a form suitable for driving the speaker 242.

The processor 226 gathers information from other system elements, including input data from the peripheral interface 224, and program instructions and other data from non-volatile storage 232 or volatile storage 230, or from other systems (e.g., a server used to store and distribute copies of executable code) coupled to a local area network or a wide area network via the network interface 228. The processor 226 executes the program instructions and processes the data accordingly. The program instructions may further configure the processor 226 to send data to other system elements, such as information presented to the user via the display interface 222 and the display 204, and audio presented to the user via the audio interface 240 and the speaker 242. The network interface 228 enables the processor 226 to communicate with other systems via a network (e.g., network 140 of FIG. 1). Volatile storage 230 may serve as a low-latency temporary store of information for the processor 226, and non-volatile storage 232 may serve as a long term (but higher latency) store of information.

The processor 226, and hence the system configuration 200 as a whole, operates in accordance with one or more programs stored on non-volatile storage 232 or received via the network interface 228. The processor 226 may copy portions of the programs into volatile storage 230 for faster access, and may switch between programs or carry out additional programs in response to user actuation of the input device. The additional programs may be retrieved from non-volatile storage 232 or may be retrieved or received from other locations via the network interface 228. One or more of these programs executes on system configuration 200 causing the configuration to perform at least some of the receiving and sending functions of receiving station 110 and sending station 120, respectively, as disclosed herein.

Although a fully equipped computer system is shown in the illustrative embodiment of FIGS. 2A and 2B, other embodiments comprise fewer options and may be suitable as the receiving station 110. At least some embodiments of receiving station 110 comprise only some of the hardware features shown in FIGS. 2A and 2B, and only execute the software necessary to establish a remote session. Such embodiments of the receiving station 110 are referred to as a “thin” client. Similarly, at least some embodiments of sending station 120 comprise only some of the hardware features shown in FIGS. 2A and 2B. For example, if sending station 120 is used exclusively as a remote host, keyboard 206, pointing device 236, speaker 242 and display 204 are not needed. Other embodiments of the receiving and sending stations, with various combinations of hardware features and installed software, will become apparent to those skilled in the art, and all such embodiments of the receiving and sending stations are intended to be within the scope of the present disclosure.

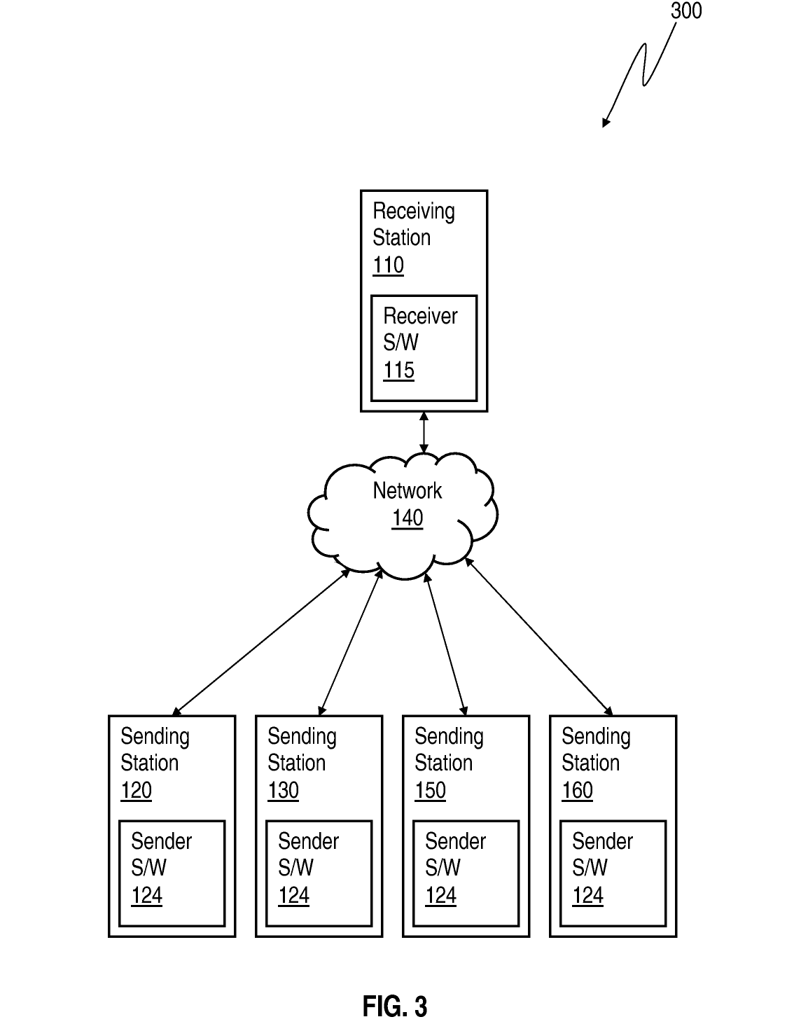

In at least some illustrative embodiments, receiver software 115 is capable of establishing multiple remote sessions, each with a separate sending station. FIG. 3 shows a system 300 comprising a single receiving station 110 executing an instance of receiver software 115 and coupled to a network 140. Four sending stations (120, 130, 150 and 160) also couple to network 140, each sending station executing an instance of sender software 124. Receiving station 110 and receiver software 115 interact with each of the sending stations (120, 130, 150 and 160) as described above with regard to receiving station 110 and sending station 120 of FIG. 1.

Continuing to refer to FIG. 3, in at least some illustrative embodiments, the receiver software executes within a host windowing operating system (e.g., Microsoft® Windows®). Remote sessions are presented to, and are controlled by, a user via a single, top-level remote session window. The user interacts with each session between the receiving station 110 and each of the sending stations (120, 130, 150 and 160) through individual sub-windows opened within the top-level remote session window. The user can select a session window while leaving it as one of several displayed windows within the top-level window, can maximize a selected session window within the top-level window to display only the selected session, or can display a selected session window in “full-screen” mode. In the full-screen mode, the borders and menus of both the top-level window and the session window are hidden from view. As a result, the session display appears as if it were the only activity being displayed, i.e., as if the user were directly logged into the sending station associated with the selected session.

Because the individual remote sessions described herein are under the control of a single top-level remote session window, the control of the display and switching of remote session described herein is limited to these remote sessions, and does not affect the behavior of windows associated with other applications concurrently displayed together with the top-level remote session window. Thus, in at least some illustrative embodiments, the top-level remote session software (e.g., at least part of receiver software 115) does not prevent the contemporaneous presentation at receiving station 110 of display information from a remote session controlled by the top-level remote session, and display information in a window associated with another application. For example, a user could display a remote session within a top-level remote session window (in a mode other than full-screen mode), while contemporaneously displaying a window associated with an email application. Those skilled in the art will recognize that a wide variety of applications may be executed and displayed contemporaneously with a top-level remote session window as described herein, including other top-level remote session windows. All such applications and combinations of applications are within the scope of the present disclosure.

In at least some illustrative embodiments, when a remote session is displayed in full-screen mode, all inputs from the user (e.g., mouse clicks and keystrokes) are redirected to the remote session, bypassing the windowing system. As a result, special key sequences that would normally be intercepted by the host windowing operating system (e.g., ALT-TAB to select a window) are sent to and processed by the sending station associated with the selected remote session. This allows the selected remote session to remain in full-screen mode until a special reserved key sequence (e.g., SHIFT-SPACE) is executed and intercepted by receiving software 115, causing the top-level remote session window to activate or enter a setup mode wherein the user can either exit the full-screen mode or switch sessions without exiting the full-screen mode.

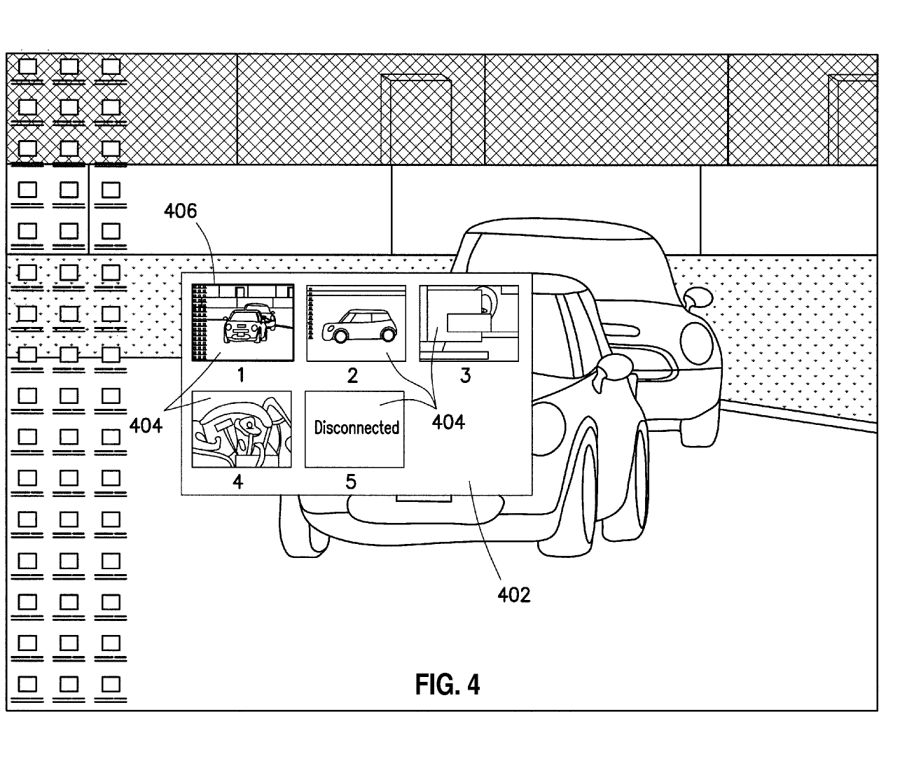

FIG. 4 shows an example of a display used to switch sessions while continuing to operate in a full-screen mode, in accordance with at least some illustrative embodiments. The selected session remains displayed in the background and continues to update. A series of thumbnail images 404 are overlaid and displayed within a selection box 402 over the currently selected session without changing windowing modes. Thus, if the current session is displayed in full-screen mode, the current session will continue to be displayed in full-screen mode with the thumbnail images displayed as an overlay on top of the current session display. The thumbnail images are scaled-down versions of the actual current display for at least some of the available sessions (as many as will fit on the display for a given thumbnail size). In at least some illustrative embodiments, the thumbnail images 404 are static snapshots of the latest display update for a given session. In other illustrative embodiments, the thumbnail images 404 are dynamic images that continue to update based upon the display data provided from the sending station corresponding to the remote session for a given thumbnail.

By using a two-key special key sequence, one key may be released while the other “setup mode” key of the sequence (e.g., the SHIFT key) continues to be held down, maintaining the top-level remote session window in a setup mode while still displaying the selected full-screen window. In at least some illustrative embodiments the user displays the selection box 402 of FIG. 4, and causes one of the thumbnails 404 shown in the selection box 402 to be highlighted in sequence, e.g., by moving a box 406 around each thumbnail image until the desired thumbnail is highlighted. The user sequences through the available session thumbnails 404 by pressing another key (e.g., the TAB key) designated as a “next session” key while continuing to hold down the setup mode key. The setup mode is exited or deactivated by releasing the setup mode key. In at least some illustrative embodiments, a dedicated setup key is used instead of a two-key sequence, and setup mode is activated/entered or deactivated/exited (i.e., toggled) with each successive pressing of the dedicated setup key. In at least some illustrative embodiments, the first press of the next session key after activating setup mode causes the thumbnail selection box 406 to be displayed over the display of the current session, and subsequent presses cause the next thumbnail 404 in sequence to be highlighted as the user sequences through potential selections.

By choosing and highlighting a thumbnail corresponding to a remote session, the user “pre-selects” a session. In at least some illustrative embodiments, the pre-selection may also be performed by single-clicking a thumbnail, and also by pressing an assigned “thumbnail identifier” key (e.g., a numeric key) corresponding to the thumbnail associated with the desired session thumbnail. During the pre-selection process, the currently selected session (not the pre-selected thumbnail session) continues to be displayed in background, which assists the user in remembering which session was last selected should the user decide not to switch sessions and return to the currently selected session. The user can return to the currently selected session by re-selecting the thumbnail corresponding to the session currently selected. Once the user has made a selection, the user releases the setup mode key, and the highlighted thumbnail 404 becomes the currently selected session (if not already the currently selected session) and is displayed in a full-screen mode. If the user reselects the currently selected session, the selection box 402 is removed from the display, and the currently selected session continues to be displayed in a full-screen mode.

In other illustrative embodiments, the user can combine the pre-selection and selection steps in to a single step by double-clicking the thumbnail of interest, causing the session associated with the thumbnail of interest to be selected and displayed. In still other illustrative embodiments, the user can combine pre-selection and selection, and switch directly to another session by pressing a numeric key corresponding to a particular session before the first press of the next session key (this presumes that the user already knows the number of the desired session). Both double-clicking selection and direct thumbnail identifier key selection automatically complete the session selection and cause the top-level remote session window to exit setup mode.

By using thumbnails reflecting a current or recent image associated with a session, the user can quickly and intuitively identify individual session based on the visual appearance of the session thumbnails. Further, the embodiments described require relatively few keystrokes and mouse clicks to switch session. Also, by not changing windowing modes and by not switching the overall context of the display presentation (e.g., by not exiting full-screen mode and returning to the windowing system's desktop), the user can focus on the session switch without having to first re-adjust to a windowing system display and/or desktop that may be cluttered with unrelated icons and program windows. The user is presented with the display information for one session at a time, unless the user decides to select another session. During the selection process the user is presented with display information from more than one session (in the form of thumbnails) to facilitate the selection process. After the selection is complete, the user is again presented with only one session display. In this manner the contemporaneous presentation of display information from more than one session is prevented outside of the setup mode.

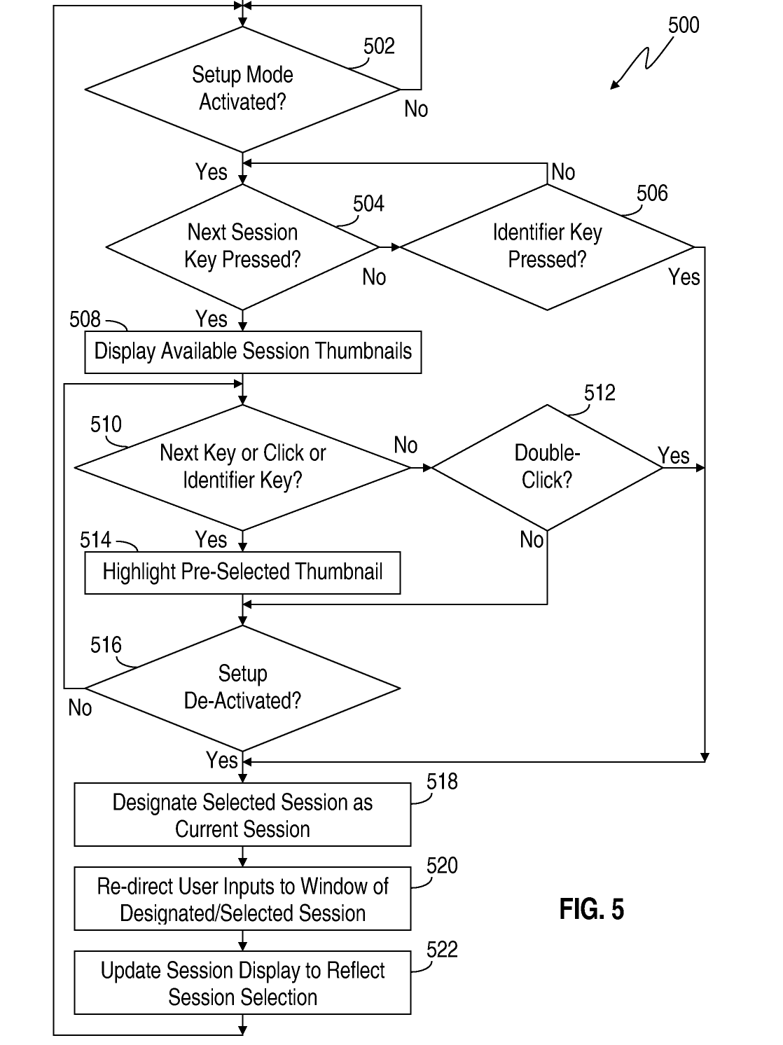

FIG. 5 shows a method 500 for switching remote sessions, in accordance with at least some illustrative embodiments. The order of the action can be changed from that shown, and one or more actions can be combined together or performed in parallel (concurrently). In at least some illustrative embodiments, the method 500 is performed within receiving station 110 of FIGS. 1 and 3 by receiver software 115.

Referring again to FIG. 5, upon detecting in block 502 that setup mode has been activated (e.g., due to a setup mode key sequence or a dedicated setup key being pressed), a check is performed to determine if the next session key (e.g., the TAB key) has been pressed (block 504). If the next session key has not been pressed, then a check is performed to determine if a thumbnail identifier key corresponding to an available session has been pressed (block 506). If such a thumbnail identifier key has not been pressed, the scan for a pressed key is repeated starting with block 504. If a thumbnail identifier key corresponding to an available session is pressed (block 506), a session selection has been made, which deactivates setup. The selected session is designated as the current session (block 518), user inputs are re-directed to the window corresponding to the selected session (block 520), and the session display is updated to reflect the new session selection (block 522). The method 500 then repeats, returning to block 502 to wait until setup mode is again activated.

Returning to block 504, if after setup mode is activated the next session key is pressed, thumbnails representing available sessions are displayed over the display of the currently selected session (block 508). If the next key is again pressed (block 510) the next thumbnail in sequence (e.g., the next thumbnail to the right of the currently highlighted thumbnail) is highlighted (block 514), indicating a pre-selection of the session associated with the highlighted thumbnail. In at least some illustrative embodiments, the user may also pre-select a session by single-clicking a thumbnail (block 510), or by pressing a thumbnail identifier key corresponding to the thumbnail number for the desired session (block 510). As with the next key, after a session is pre-selected the corresponding thumbnail is highlighted (block 514).

After a pre-selected session thumbnail is highlighted, a check is performed in block 516 to determine is setup has been deactivated (e.g., by releasing a setup key of a setup key sequence, or by toggling out of setup mode by pressing a dedicated setup key). If setup has not been deactivated, blocks 510-516 of method 500 are repeated until setup mode is deactivated. When setup mode is deactivated, the pre-selected session becomes the selected session, which is designated as the current session (block 518). User inputs are re-directed to the window corresponding to the selected session (block 520), and the session display is updated to reflect the new session selection (block 522). The method 500 repeats, returning to block 502 and waiting until setup mode is again activated.

If neither the next key nor a number key corresponding to an available session have been pressed (block 510), and a thumbnail has not been single-clicked (block 510), a check is performed to determine if a thumbnail has been double-clicked (block 512). If no thumbnail has been double-clicked, the setup de-activation check of block 516 is again executed, and blocks 510-516 of method 500 continue to be performed until setup mode is deactivated. If a thumbnail is double-clicked (block 512), a session selection has been made, deactivating setup mode. The selected session is designated as the current session (block 518), user inputs are re-directed to the window corresponding to the selected session (block 520), and the session display is updated to reflect the new session selection (block 522). The method 500 then repeats, returning to block 502 to wait until setup mode is again activated.

The above discussion is meant to be illustrative of the principles and various embodiments of the present invention. Numerous variations and modifications will become apparent to those skilled in the art once the above disclosure is fully appreciated. For example although the illustrative embodiments of the present disclosure are shown and described within the context of a session displayed in full screen mode, other illustrative embodiments comprise performing the methods described in the context of a maximized, restored and/or normalized window displayed on a desktop. It is intended that the following claims be interpreted to embrace all such variations and modifications.

What is claimed is:

1. A method for selecting a remote session, comprising:
presenting display information to a user, while in a first windowing mode, from a first remote session before entering a setup mode, and from a second remote session after exiting the setup mode;
entering the setup mode and selecting, by the user, the second remote session while continuing to present the display information from the first remote session without changing to a second windowing mode; and
preventing contemporaneous presenting of display information from both the first and the second remote sessions while not in the setup mode.

2. The method of claim 1, further comprising redirecting at least some input from the user away from the first remote session when entering the setup mode, and to the second remote session upon exiting the setup mode.

3. The method of claim 2, further comprising using the at least some input from the user while in the setup mode to control the selecting of the second remote session.

4. The method of claim 1, further comprising:
displaying thumbnail representations of the display information from both the first and second remote sessions on top of the display information from the first remote session while in the setup mode; and
selecting the second remote session by double-clicking the thumbnail using a pointing device.

5. The method of claim 1, further comprising
displaying thumbnail representations of display information from both the first and second remote sessions on top of the display information from the first remote session while in the setup mode; and
selecting the second remote session by highlighting a thumbnail associated with the second remote session.

6. The method of claim 5, further comprising highlighting the thumbnail by performing at least one action selected from the group consisting of single-clicking on the thumbnail with a pointing device, pressing a key one or more times to cause a highlighting indicator to move to the thumbnail, and pressing a thumbnail identifier key to cause the highlighting indicator to move to a thumbnail associated with the identifier key.

7. The method of claim 1, further comprising selecting of the second remote session by pressing, while in the setup mode, a thumbnail identifier key corresponding to a number assigned to the second remote session.

8. The method of claim 1, further comprising entering the setup mode by contemporaneously pressing two keys on a keyboard, then releasing a first key while continuing to press a second key, and exiting the setup mode by releasing the second key.

9. The method of claim 1, further comprising entering the setup mode by pressing and releasing a setup key on a keyboard while not in the setup mode, and exiting the setup mode by pressing and releasing the setup key while in the setup mode.

10. A computer-readable medium comprising software that causes a processor to:
present display information to a user, while in a first windowing mode, from a first remote session before entering a setup mode, and from a second remote session after exiting the setup mode;
enter the setup mode and detect a selection, by the user, of the second remote session while continuing to present the display information from the first remote session without changing to a second windowing mode; and
prevent contemporaneous presentation of display information from both the first and the second remote sessions while not in the setup mode.

11. The computer-readable medium of claim 10, wherein the software further causes the processor to:
redirect at least some input from the user away from the first remote session when the setup mode is entered, and to the second remote session when the setup mode is exited; and
use the at least some input from the user while in the setup mode to control the selection of the second remote session.

12. The computer-readable medium of claim 10, wherein the software further causes the processor to:
display thumbnail representations of the display information from both the first and second remote sessions on top of the display information from the first remote session while in the setup mode; and
select the second remote session by double-clicking the thumbnail using a pointing device.

13. The computer-readable medium of claim 10, wherein the software further causes the processor to:
display thumbnail representations of display information from both the first and second remote sessions on top of the display information from the first remote session while in the setup mode; and
select the second remote session by highlighting a thumbnail associated with the second remote session.

14. The computer-readable medium of claim 13, wherein the software further causes the processor to highlight the thumbnail by single-clicking on the thumbnail with a pointing device.

15. The computer-readable medium of claim 13, wherein the software further causes the processor to highlight the thumbnail by pressing a key one or more times, and causes a highlighting indicator to move to the thumbnail.

16. The computer-readable medium of claim 13, wherein the software further causes the processor to highlight the thumbnail by pressing a thumbnail identifier key, and causes a highlighting indicator to move to the thumbnail, the number of the thumbnail identifier key corresponds to a number assigned to the second remote session.

17. The computer-readable medium of claim 10, wherein the software further causes the processor to select the second remote session by pressing, while in the setup mode, a thumbnail identifier key corresponding to a number assigned to the second remote session.

18. A receiving station, comprising:
logic configured to establish at least a first and a second remote session with one or more sending stations, the logic causes display information to be presented to a user while in a first windowing mode, and the logic further prevents contemporaneous display information presentation from both the first and second remote sessions while not in a setup mode;
wherein the display information presented to the user originates from the first remote session after setup mode entry, without changing to a second windowing mode, while the user selects the second remote session.

19. The receiving station of claim 18,
wherein the logic further redirects at least some input from the user away from the first remote session the setup mode entry, and to the second remote session after setup mode exit; and
wherein the logic further uses the at least some input from the user while in the setup mode to control the selection of the second remote session.

20. The receiving station of claim 19,
wherein the logic further presents thumbnail representations of display information from both the first and second remote sessions on top of the display information presented from the first remote session while in the setup mode; and
wherein the display information presented is switched from the first remote session to the second remote session in response to a user selection of a thumbnail representation of the second remote session.
